(19) United States
(12) Patent Application Publication
(10) Pub. No.: US 2008/0138499 A1
(43) Pub. Date: Jun. 12, 2008

(54) LIQUID MATERIAL ARRANGEMENT METHOD, DEVICE MANUFACTURING METHOD, AND LIQUID MATERIAL DISCHARGE DEVICE

(75) Inventors: Kei HIRUMA, Chino-shi (JP); Hirofumi Kobayashi, shiojiri-shi (JP); Tatsuya Ito, Matsumoto-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/935,583

(22) Filed: Nov. 6, 2007

(30) Foreign Application Priority Data
Nov. 22, 2006 (JP) JP 2006-316012

(51) Int. Cl. B05D 1/02; B05B 1/30

(52) U.S. Cl. 427/8; 239/690; 118/712

(57) ABSTRACT

A liquid material arrangement method is performed to arrange a liquid material on a discharge object with the liquid material being discharged from a nozzle of a head according to an electrical signal supplied to a drive unit. The liquid material arrangement method includes measuring a discharge quantity of the liquid material discharged from the nozzle according to the electrical signal corresponding to a prescribed condition, detecting a first temperature in a vicinity of the head while the discharge quantity is measured, detecting a second temperature in the vicinity of the head in a condition in which the liquid material is discharged onto the discharge object, and generating the electrical signal corresponding to a condition determined based on the discharge quantity, the first temperature and the second temperature, and supplying the generated electrical signal to the head to arrange the liquid material on the discharge object.

### CROSS-REFERENCE TO RELATED APPLICATIONS

This application claims priority to Japanese Patent Application No. 2006-316012 filed on Nov. 22, 2006. The entire disclosure of Japanese Patent Application No. 2006-316012 is hereby incorporated herein by reference.

### BACKGROUND OF THE INVENTION

1. Technical Field

The present invention relates to a liquid material discharge device and a liquid material arrangement method for the liquid material discharge device, and to a device manufacturing method that uses the liquid material arrangement method.

2. Related Art

Methods have recently been proposed for discharging a liquid material that includes a functional material from a micro-nozzle to a substrate, and curing the liquid material arranged on the substrate to form a thin film. Representative examples of such thin films include color filters, luminescent layers, metal wiring, and the like.

In such a method, consistency must be maintained in the discharged quantity (hereinafter referred to as the discharge quantity) of the liquid material in order to form a good-quality thin film. The reason for this is that the discharge quantity may fluctuate due to degradation of hardware elements through the discharge history, manufacturing variations in the liquid material, and other factors. A liquid material discharge device has therefore been proposed in which a measurement means for the discharge quantity is provided, and a drive condition relating to discharge is adjusted on the basis of the measurement result (for example, Japanese Laid-open Patent Application No. 2004-209429).

In view of the above, it will be apparent to those skilled in the art from this disclosure that there exists a need for an improved liquid material arrangement method. This invention addresses this need in the art as well as other needs, which will become apparent to those skilled in the art from this disclosure.

### SUMMARY

In order to stabilize the discharge quantity, the temperature of the liquid material is an important factor that affects the discharge. The reason for this is that the viscosity of the liquid material varies according to the temperature, and therefore affects the discharge quantity as a result. A slight difference in the temperature of the liquid material is caused by the positional relationship with a heat source within the device during measurement of the discharge quantity and actual drawing, and this effect makes it difficult to adjust the drive conditions with high precision.

The present invention was developed to overcome the drawbacks described above, and an object of the present invention is to provide a liquid material discharge device and liquid material arrangement method whereby a stable discharge quantity can be maintained, and to provide a device manufacturing method that uses the liquid material arrangement method.

According to the first aspect of the present invention, a liquid material arrangement method is performed for arranging a liquid material on a discharge object with the liquid material being discharged from a nozzle of a head according to an electrical signal supplied to a drive unit. The liquid material arrangement method includes measuring a discharge quantity of the liquid material discharged from the nozzle according to the electrical signal corresponding to a prescribed condition, detecting a first temperature in a vicinity of the head while the discharge quantity is measured, detecting a second temperature in the vicinity of the head in a condition in which the liquid material is discharged onto the discharge object, and generating the electrical signal corresponding to a condition determined based on the discharge quantity, the first temperature and the second temperature, and supplying the generated electrical signal to the head to arrange the liquid material on the discharge object.

In the liquid material arrangement method of the present invention, the electrical signal condition relating to arrangement of the liquid material is adjusted based on a discharge quantity that is measured in advance. Since the first temperature at the time of discharge quantity measurement, and the second temperature at the time of liquid material arrangement are referenced at this time, the effects of a temperature difference in the periphery of the head between the time of discharge quantity measurement and the time of liquid material arrangement can be suitably eliminated, and the electrical signal condition can be suitably adjusted.

The liquid material arrangement method is preferably arranged such that the condition of the electrical signal is a voltage component.

The liquid material arrangement method is also preferably arranged such that detection of the first temperature and the second temperature include detecting at least one of a temperature at a periphery of a surface of the head on which the nozzle is formed and a temperature at a periphery of an introduction part for introducing the liquid material to the head.

The liquid material arrangement method is also preferably arranged such that the detecting of the second temperature and the generating of the electrical signal are performed one or more times for the discharge object.

The liquid material arrangement method is also preferably arranged to further include discharging the liquid material from a plurality of heads, and the detecting of the first and second temperatures including detecting one of a temperature of one portion of the heads and a temperature of each of the heads.

According to the second aspect of the present invention, a liquid material arrangement method is performed for arranging a liquid material on a discharge object with the liquid material being discharged from a nozzle of a head according to an electrical signal supplied to a drive unit. The liquid material arrangement method includes measuring a first preliminary discharge quantity of the liquid material discharged in a first area of the discharge object according to the electrical signal corresponding to a prescribed condition, measuring a second preliminary discharge quantity of the liquid material discharged in a second area that is separate from the first area according to the electrical signal corresponding to the prescribed condition, measuring a discharge quantity of the liquid material discharged in the second area in a condition in which the liquid material is discharged onto the discharge object according to the electrical signal corresponding to the prescribed condition, and generating the electrical signal corresponding to a condition determined based on the first and second preliminary discharge quantities and the discharge quantity, and supplying the generated electrical signal to the head to arrange the liquid material on the discharge object.

According to the third aspect of the present invention, a method for manufacturing a device that is provided with a film as a constituent element includes performing the liquid material arrangement method as described above to arrange the liquid material on a substrate, and curing the liquid material arranged on the substrate to form the film.

According to the fourth aspect of the present invention, a liquid material discharge device includes a head, a discharge quantity measurement section, a first temperature detecting section, an arrangement control section, a second temperature detecting section and an electrical signal control section. The head includes a nozzle configured and arranged to discharge a liquid material according to an electrical signal supplied to a drive unit. The discharge quantity measurement section is configured and arranged to measure a discharge quantity of the liquid material discharged on to a discharge object according to the electrical signal corresponding to a prescribed condition. The first temperature detecting section is configured and arranged to detect a first temperature in a vicinity of the head while the discharge quantity is measured by the discharge quantity measurement section. The arrangement control section is configured to discharge the liquid material from the nozzle to arrange the liquid material on the discharge object. The second temperature detecting section is configured to detect a second temperature in the vicinity of the head in a condition in which the liquid material is discharged onto the discharge object by the arrangement control section. The electrical signal control section is configured to control a condition of the electrical signal that is supplied to the drive unit during arrangement of the liquid material by the arrangement control section based on the discharge quantity, the first temperature and the second temperature.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a perspective view showing the configuration of the relevant parts of the liquid material discharge device;

FIG. 2 is a plan view showing the arrangement configuration of the head in the head unit;

FIG. 3 is a block diagram showing the electrical configuration of the liquid material discharge device;

FIG. 4 is a diagram showing an example of the drive signal;

FIG. 5 is a flowchart showing the flow of routines performed by the liquid material discharge device;

FIG. 6 is a flowchart showing the flow of routines performed by the liquid material discharge device according to a second embodiment; and

FIG. 7 is an exploded perspective view showing the overall structure of the liquid crystal display device.

### DETAILED DESCRIPTION OF THE PREFERRED EMBODIMENTS

Preferred embodiments of the present invention will be described in detail hereinafter based on the accompanying drawings.

The embodiments described below are preferred specific examples of the present invention and therefore include various limits that are technically preferred, but the scope of the present invention is not limited by these embodiments insofar as the description below does not specifically limit the present invention. The reduction of the vertical and horizontal scale of members and components is sometimes shown differently than the actual scale for convenience in the drawings referenced in the description below.

### Mechanical Structure of Liquid Material Discharge Device

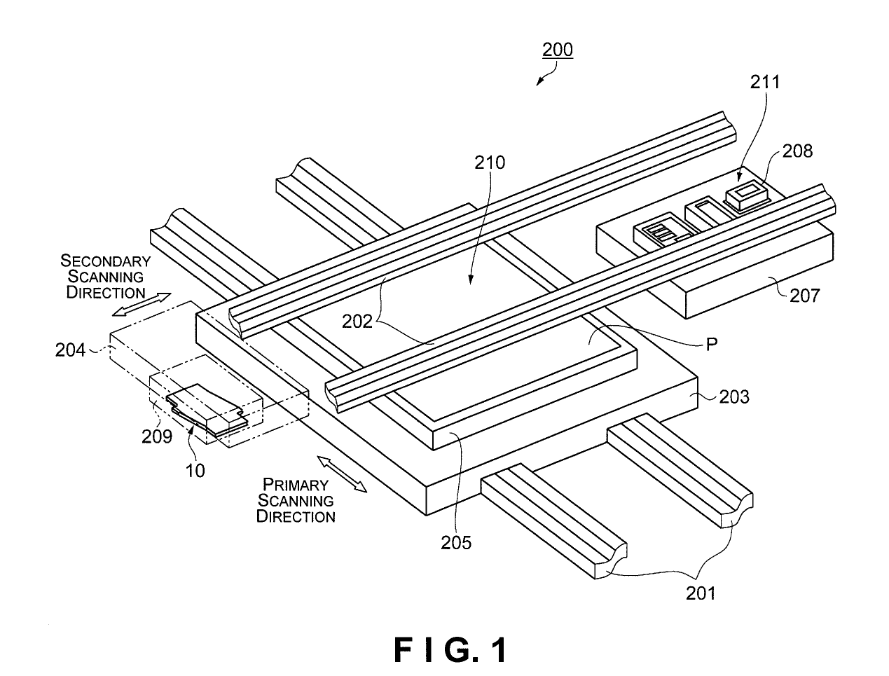

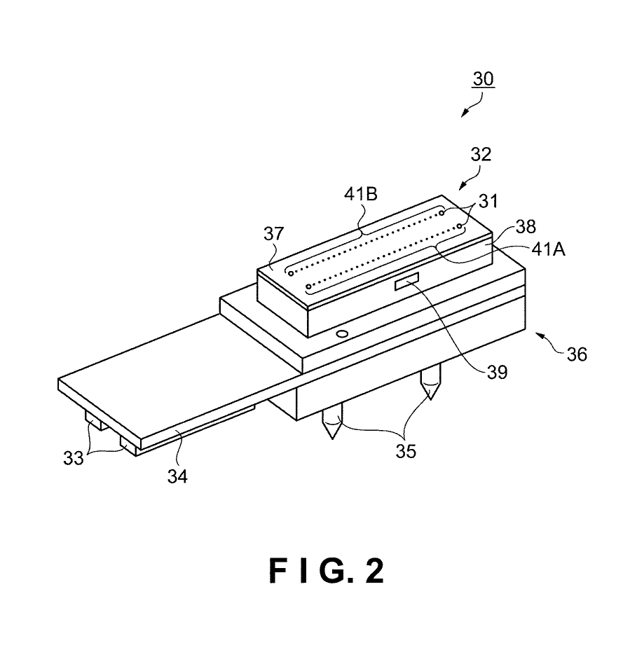

The mechanical structure of the liquid material discharge device used in the liquid material arrangement method of the present invention will next be described with reference to FIGS. 1 and 2.

FIG. 1 is a perspective view showing the configuration of the relevant parts of the liquid material discharge device. FIG. 2 is a plan view showing the arrangement configuration of the head in the head unit.

The liquid material discharge device 200 shown in FIG. 1 is provided with a pair of guide rails 201 provided linearly, and a primary scanning stage 203 for moving in the primary scanning direction through the use of an air slider and a linear motor (not shown) provided inside the guide rails 201. A pair of guide rails 202 provided linearly so as to be orthogonal to the guide rails 201 is provided above the guide rails 201, and a secondary scanning stage 204 is provided for moving along the secondary scanning direction through the use of an air slider and a linear motor (not shown) provided inside the guide rails 202.

A stage 205 for mounting a substrate P as the discharge object is provided on the primary scanning stage 203. The stage 205 is configured so as to be capable of attaching and fixing the substrate P, and a reference axis in the substrate P can be properly aligned with the primary scanning direction and the secondary scanning direction through the use of a rotation mechanism (not shown).

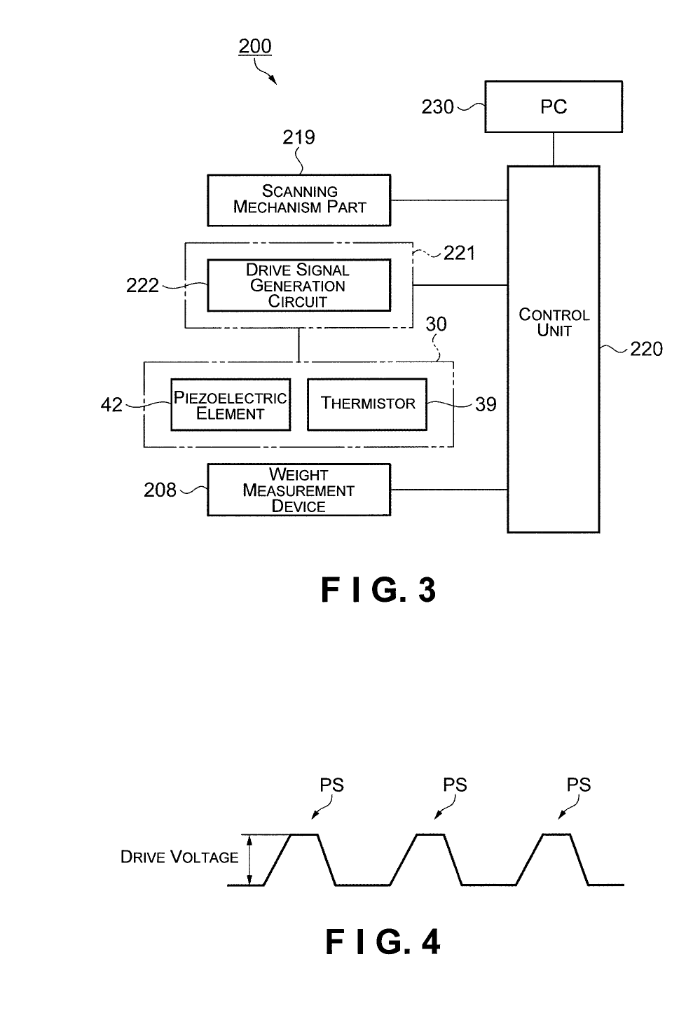

The secondary scanning stage 204 is provided with a carriage 209 that is attached by suspension. The carriage 209 is provided with a head unit 10 that is provided with a plurality of heads 30 (see FIG. 2); a liquid material feeding mechanism (not shown) for supplying the liquid material to the heads 30; and a drive circuit board 221 (see FIG. 3) for generating an electrical signal (hereinafter referred to as a drive signal) that is fed to the heads 30.

As shown in FIG. 2, the heads 30 are provided with a discharge assembly 32, a circuit substrate 34 that has an electrical cable and connectors 33, and a case assembly 36 that has liquid material introduction parts 35. One surface of the discharge assembly 32 is a nozzle formation surface 37 in which a plurality of nozzles 31 is arranged, and a thermistor 39 is attached to the side surface 38 that forms the surface perpendicular to the nozzle formation surface 37. The thermistor 39 constitutes the first temperature detecting section and the second temperature detecting section of the present invention configured and arranged to detect the temperature in the periphery of the nozzle formation surface 37. The position at which the thermistor 39 is attached may be appropriately modified, e.g., the thermistor 39 may be attached in the vicinity of the liquid material introduction parts 35.

In the nozzle formation surface 37, the nozzles 31 form two nozzle groups 41A, 41B, and the nozzles 31 of the nozzle groups 41A, 41B form lines at a prescribed pitch in a prescribed direction. The arrangement directions of nozzle group 41A and nozzle group 41B match each other, and nozzle group 41A and nozzle group 41B are in a so-called staggered relationship to each other in which the nozzles are arranged so that the pitches complement each other.

Liquid chambers (cavities) communicated with the nozzles 31 formed in the discharge assembly 32 are configured so that the volume thereof is varied by the driving of piezoelectric elements 42 (see FIG. 3) that are connected to movable walls of the liquid chambers. The liquid material (droplets) can be discharged from the nozzles 31 by supplying drive signals to the piezoelectric elements 42 to control the liquid pressure inside the cavities. Specifically, the piezoelectric elements 42 constitute the drive unit of the present invention. Besides piezoelectric elements, heating elements may also be used as the drive unit.

With reference to FIG. 1, in a state in which the carriage 209 is moved to a drawing area 210 as a position directly above the substrate P, relative scanning (scanning) of the head unit 10 and the substrate P, and ON/OFF control of discharge for each nozzle 31 are performed, whereby the liquid material is arranged (drawn) on the substrate P. Specifically, The abovementioned guide rails 201, 202, the primary scanning stage 203, the secondary scanning stage 204, the stage 205, and the carriage 209 constitute the arrangement control section in the present invention. The drawing area 210 corresponds to the first area in the present invention.

A maintenance unit 207 for performing capping (sealing) of the nozzles 31 (see FIG. 2), a forced evacuation operation (restoration), wiping (wiping), and various other maintenance operations is provided in a position several meters away in the secondary scanning direction from the movement region of the primary scanning stage 203. The maintenance unit 207 is also provided with a weight measurement device 208 that is provided with a liquid material receptacle and an electronic balance for mounting the liquid material receptacle, and the weight (discharge quantity) of the liquid material relating to a discharge can be measured by discharging the liquid material in a state in which the carriage 209 is moved to a weight measurement area 211 that is a position directly above the maintenance unit 207. Specifically, the weight measurement device 208 constitutes the discharge quantity measurement section of the present invention. The weight measurement area 211 corresponds to the second area in the present invention.

### Electrical Configuration of Liquid Material Discharge Device

The electrical configuration of the liquid material discharge device used in the liquid material arrangement method of the present invention will next be described with reference to FIGS. 3 and 4.

FIG. 3 is a block diagram showing the electrical configuration of the liquid material discharge device. FIG. 4 is a diagram showing an example of the drive signal.

In FIG. 3, the liquid material discharge device 200 is provided with a control unit 220 that is composed of a CPU or memory; a scanning mechanism part 219 for moving the carriage 209 (see FIG. 1) and other components; a drive circuit substrate 221 that has a drive signal generation circuit 222; the heads 30; and the weight measurement device 208. The control unit 220 receives various command from a PC (personal computer) 230 that acts as a user interface, and performs computational processing and the like relating to drive control of the scanning mechanism part 219, drive control of the heads 30 (hereinafter referred to as discharge control), and measurement of the weight measurement device 208. The control unit 220 is configured so as to acquire temperature information detected by the thermistor 39 and store the temperature information in internal memory.

Discharge control of the heads 30 is performed by supplying a drive signal generated in the drive signal generation circuit 222 to the piezoelectric elements 42. As shown in FIG. 4, the drive signal is composed of a connected series of periodic pulse groups PS that include charge and discharge pulses. In the present embodiment, the cavities are depressurized by the charge pulses in the pulse groups PS and are pressurized by the discharge pulses, and a single liquid material (droplet) is discharged by the feeding of a single pulse group. Specifically, the generation timing of each pulse group PS corresponds to the timing of each discharge control.

The voltage that corresponds to the difference between the lowest potential and the highest potential in a pulse group PS is referred to as a drive voltage, which is a parameter for controlling the discharge quantity as described hereinafter. Specifically, the amount of displacement in a piezoelectric element varies according to the drive voltage, and the discharge quantity has a substantially linear correlation to the drive voltage. The discharge quantity can also be controlled by a time component of the charge/discharge pulses or a time component of connection between charge/discharge pulses, but control by drive voltage is superior in terms of ease of use, and this method is therefore used in the present embodiment.

### Liquid Material Arrangement Method

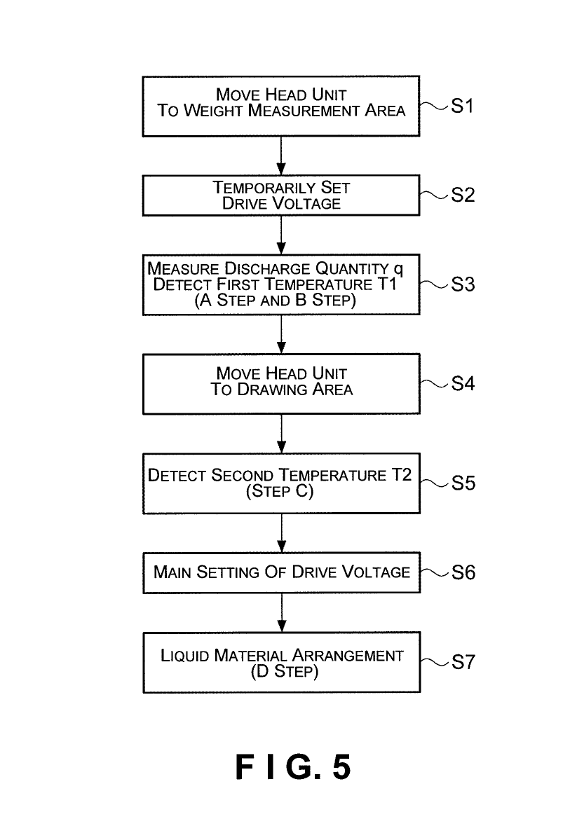

The liquid material arrangement method (drawing method) will next be described according to the flowchart of FIG. 5 and with reference to FIGS. 1 and 3.

FIG. 5 is a flowchart showing the flow of routines performed by the liquid material discharge device.

In this method, the scanning mechanism part 219 is first driven to move the head unit 10 to the weight measurement area 211 (step S1). Temporary setting of the drive voltage is then performed for the heads 30 attached to the head unit 10 (step S2). This temporary setting is performed for each nozzle group 41A, 41B (see FIG. 2) of the heads 30, and is performed based on ID information that is set when the heads 30 are checked prior to shipping, for example.

In the next step S3, the liquid material is discharged to the weight measurement device 208 according to the temporarily set drive voltage, and the discharge quantity q is measured (this step corresponds to the A step in the present invention). The first temperature T1 is detected at this time by the thermistor 39 (this step corresponds to the B step in the present invention).

In the measurement of the discharge quantity q, a plurality (e.g., several tens of thousands of dots per nozzle) of droplets from each nozzle group 41A, 41B (see FIG. 2) of the heads 30 is discharged to the weight measurement device 208, and the total weight of the droplets is measured. In the control unit 220, the data of the total weight are divided by the total number of discharge drives, whereby the discharge quantity q per droplet is acquired and stored in the memory of the control unit 220.

The detection of the first temperature T1 is performed for each head 30. The discharge of the liquid material in step S3 includes a plurality of cycles, and therefore requires a certain amount of time (a few seconds), but the first temperature T1 is acquired as the average detected value in the time period, for example, or the detected value of a prescribed time during the period. The acquired first temperature T1 is stored in memory in the control unit 220.

The steps S1 through S3 described above function as preparation steps for setting the drive voltage relating to the drawing operation (step S6 described hereinafter). Therefore, steps S1 through S3 are appropriately executed periodically, according to an instruction from the operator, or as an interruption of the drawing operation (steps S4 through S7 described hereinafter) executed over a long period of time.

The drawing operation is composed of steps S4 through S7 described hereinafter. Specifically, the head unit 10 is moved to the drawing area 210 (step S4), the second temperature T2 is then detected (step S5 corresponding to the C step of the present invention), and the detected second temperature T2 is stored in the memory of the control unit 220. The control unit 220 performs main setting of the drive voltage V using Equation 1 with the first temperature T1, the second temperature T2, and the discharge quantity q stored in the memory as parameters (step S6), and feeds the drive voltage generated according to the main setting of the drive voltage V to the piezoelectric elements 42 to arrange (draw) the liquid material (step S6 corresponds to the D step of the present invention).

V=V_{O}+α(q−q_{O})+β(T2−T1) (Equation 1)

In Equation 1, V_{O} is the temporarily set (step S2) drive voltage, and q_{O} is the specification value of the discharge quantity. The term α is a correction coefficient indicating the amount of variation of the drive voltage that is necessary to correct the discharge quantity per unit of discharge quantity, and β is a correction coefficient indicating the amount of variation of the drive voltage that is needed to correct the discharge quantity per unit of temperature. The coefficients α and β are each constants that are obtained by experimentation in advance.

The second term “α(q−q_{O})” in Equation 1 indicates an amount of voltage correction to be applied to V_{O} in order to compensate for the difference between the specification quantity q_{O} and the discharge quantity q that is measured using the weight measurement device 208. Specifically, this term indicates an amount of voltage correction for compensating for contributing factors to discharge quantity fluctuation due to degradation of hardware elements over the discharge history, manufacturing variations in the liquid material, and other factors, and for causing the discharge quantity during the drawing operation to approach the specification value q_{O}.

However, when there is a temperature difference between the first temperature T1 that is the environmental temperature during weight measurement, and the second temperature T2 that is the environmental temperature during the drawing operation (there is a certain difference in the actual temperature according to the positional relationship to a heat source in the device structure), this temperature difference makes it impossible to perform a precise correction even when a correction is made according to the second term. For example, when the first temperature T1 is lower than the second temperature T2, an amount of the liquid material equal to or greater than the specification value q_{O} is discharged when correction is performed merely according to the second term. The third term “β(T2−T1)” in Equation 1 is a correction term that is introduced in view of such a problem in order to eliminate the effects of a temperature difference between the time of weight measurement and the time of the drawing operation, and in the present embodiment, drawing can be performed according to an electrical signal that is corrected with high precision.

Setting of the drive voltage in step S5 is performed per nozzle group 41A, 41B (see FIG. 2) of the heads 30, at which time values that correspond to the nozzle groups 41A, 41B are referenced for the temporarily set drive voltage V_{O} and discharge quantity q, respectively. Values that correspond to each of the heads 30 are referenced for the first temperature T1 and the second temperature T2. The values applied as the correction coefficients α, β are specific to the type of liquid material.

The sequence of steps in steps S5 through S7 are preferably performed periodically in a continuous drawing operation, e.g., at the timing at which the substrate P is switched, the timing of each primary scan, or the timing of each discharge control. Such a configuration makes it possible to rapidly respond to changes in the environmental temperature (second temperature) during the drawing operation, and to achieve even greater stabilization of the discharge quantity.

### Second Embodiment of Liquid Material Arrangement Method

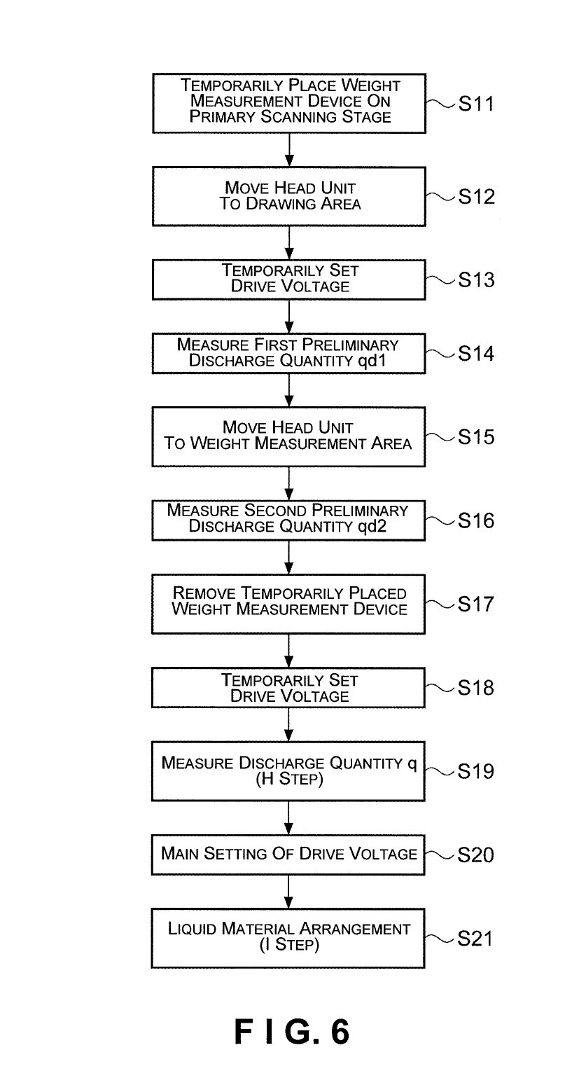

The liquid material arrangement method according to a second embodiment will next be described with reference to FIG. 6.

FIG. 6 is a flowchart showing the flow of routines performed by the liquid material discharge device according to the second embodiment.

In this method, the weight measurement device (having the same configuration as the device mounted on the maintenance unit 207) is temporarily placed on the primary scanning stage 203 (step S11). The head unit 10 is then moved to the drawing area 210 (step S12), the drive voltage is temporarily set (step S13), the liquid material is discharged to the weight measurement device that was temporarily placed in step S11, and a first preliminary discharge quantity qd1 is measured as the discharge quantity (step S14). Temporary setting of the drive voltage in step S13 and measurement of the first preliminary discharge quantity qd1 in step S14 are performed by the same methods as in step S2 and step S3, respectively, of the first embodiment. The first preliminary discharge quantity qd1 thus measured is stored in memory in the control unit 220.

The head unit 10 is then moved to the weight measurement area 211 (step S15), the liquid material is discharged to the weight measurement device 208, and a second preliminary discharge quantity qd2 is measured as the discharge quantity (step S16). Measurement of the second preliminary discharge quantity qd2 in step S16 is performed using the same lot of liquid material and the same drive voltage as was used to measure the first preliminary discharge quantity qd1. The second preliminary discharge quantity qd2 thus measured is stored in memory in the control unit 220. The temporarily placed weight measurement device is then removed (step S17).

The steps S11 through S17 described above are steps for finding a variation in discharge quantity due to a difference in the environments (primarily temperature) between the positions of the drawing area 210 and the weight measurement area 211, and serve as preliminary steps for setting (step S20 described hereinafter) the drive voltage for the drawing operation. Specifically, steps S1 through S17 correspond to the G step in the present invention. The steps S11 through S17 are performed at startup of the liquid material discharge device 200, as well as when there is a change in the installation environment or structure of the device.

The subsequent steps S18 through S20 are appropriately executed periodically, according to an instruction from the operator, or as an interruption of the drawing operation (step S21 described hereinafter) executed over a long period of time, and are performed in order to produce a condition for compensating for factors that cause the discharge quantity to fluctuate due to degradation of hardware elements over the discharge history, manufacturing variation of the liquid material, and other factors.

Specifically, the drive voltage is temporarily set in step S18 (step S18), the liquid material is discharged to the weight measurement device 208 in step S19, and the discharge quantity q is measured (step S19 as the H step in the present invention). The measured discharge quantity q is stored in memory in the control unit 220. In step S20 (which corresponds to the I step in the present invention), the control unit 220 performs main setting of the drive voltage V using Equation 2 with the first preliminary discharge quantity qd1, the second preliminary discharge quantity qd2, and the discharge quantity q stored in the memory as parameters.

V=V_{O}+α{q+(qd1−qd2)−q_{O}} (Equation 2)

In Equation 2, V_{O} is the temporarily set (step S18) drive voltage, and q_{O} is the specification value for the discharge quantity. The term α is a correction coefficient indicating the amount of variation of the drive voltage that is necessary to correct the discharge quantity per unit of discharge quantity, and is a constant that is obtained by experimentation.

The term “(qd1−qd2)” in Equation 2 indicates the inherent measurement error due to the positional difference in environment between the drawing area 210 and the weight measurement area 211. This correction term is introduced in order to eliminate the effects of fluctuation in the discharge quantity due to an environmental difference between the areas, and in the present embodiment, drawing can be performed according to an electrical signal that is corrected with high precision.

### Liquid Crystal Display Device Manufacturing Method

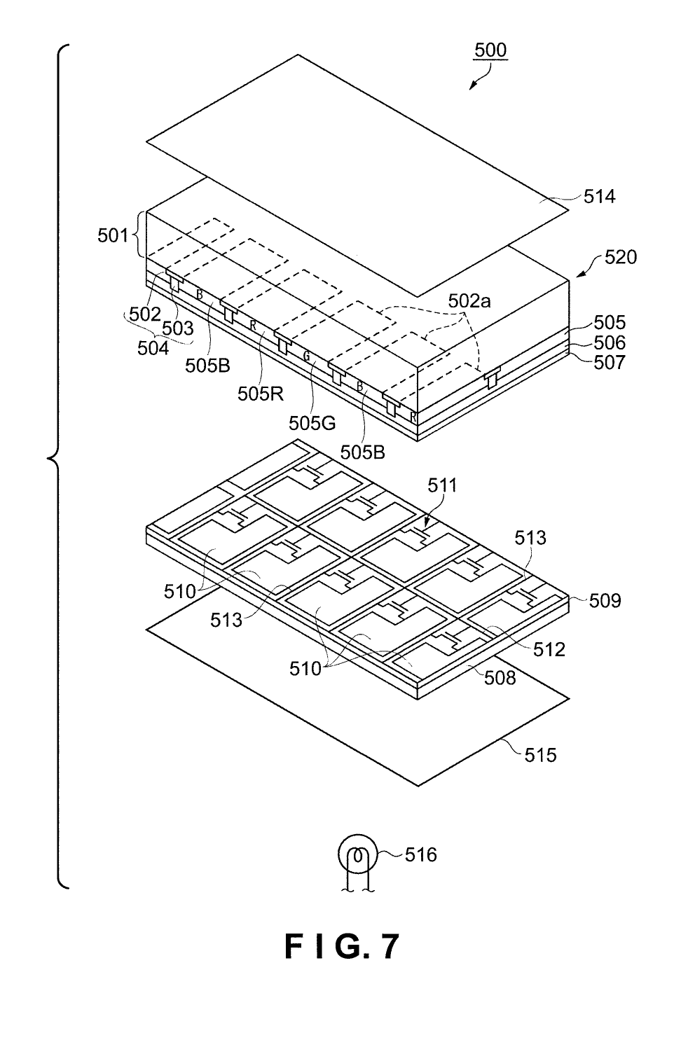

A method for manufacturing a liquid crystal display device as the device of the present invention will next be described with reference to FIG. 7.

FIG. 7 is an exploded perspective view showing the overall structure of the liquid crystal display device.

As shown in FIG. 7, the liquid crystal display device 500 is provided with a TFT (Thin Film Transistor) transmissive liquid crystal display panel 520 and an illumination device 516 for illuminating the liquid crystal display panel 520. The liquid crystal display panel 520 is provided with an opposing substrate 501 having color filters 505 as color layers; an element substrate 508 having TFT elements 511 in which one of three terminals is connected to a pixel electrode 510; and liquid crystals (not shown) that are held between both substrates 501, 508. An upper polarizer 514 and a lower polarizer 515 for polarizing the transmitted light are provided to the surfaces of both substrates 501, 508 that form the outside of the liquid crystal display panel 520.

The opposing substrate 501 is composed of transparent glass or another material, and a plurality of types (three colors: RGB) of color layers 505R, 505G, 505B is formed in a plurality of color regions that is partitioned into a matrix by barrier parts 504 on the surfaces that sandwich the liquid crystal. The barrier parts 504 are composed of lower-layer banks 502 referred to as a black matrix that are composed of Cr or another metal or oxide thereof that has light-blocking properties, and upper-layer banks 503 composed of an organic compound that are formed on (downward in the drawing) the lower-layer banks 502. The opposing substrate 501 is provided with an overcoat layer (OC layer) 506 as a planarizing layer for covering the color layers 505R, 505G, 505B that are partitioned by the barrier parts 504; and an opposing electrode 507 composed of ITO (Indium Tin Oxide) or another transparent conductive film that is formed so as to cover the OC layer 506. The color layers 505R, 505G, 505B are manufactured using the color filter manufacturing method described hereinafter.

The element substrate 508 is also composed of a glass or other transparent material, and has pixel electrodes 510 formed in a matrix via an insulation film 509 on the side on which the liquid crystals are sandwiched, and a plurality of TFT elements 511 formed so as to correspond to the pixel electrodes 510. Of the three terminals of the TFT elements 511, the other two terminals that are not connected to the pixel electrodes 510 are connected to scanning lines 512 and data lines 513 that are arranged in a lattice so as to surround and insulate the pixel electrodes 510 from each other.

The illumination device 516 may be any illumination device that uses a white LED, EL, cold cathode tube, or the like as a light source, and that has a structure provided with a light-guide plate, a diffusion plate, a reflection plate, or the like that is capable of emitting the light from the light source to the liquid crystal display panel 520.

Orientation films for aligning the liquid crystal molecules in a prescribed direction are formed on the surfaces of the opposing substrate 501 and the element substrate 508 that hold the liquid crystal, but the orientation films are not shown in the drawing. The upper and lower polarizers 514, 515 may also be combined with phase difference films or other optically functional films that are used for such purposes as improving the viewing angle dependency. The liquid crystal display panel 520 is not limited to having TFT elements as the active elements, and may have a TFD (Thin Film Diode) element. When the liquid crystal display panel 520 is provided with a color filter on at least one of the substrates, the liquid crystal display panel 520 may be a passive liquid crystal display device in which the electrodes constituting the pixels are arranged so as to intersect each other.

The scanning lines 512, the data lines 513, the color filters 505R, 505G, 505B, the overcoat layer 506, the opposing electrode 507, the pixel electrode 510, the orientation films, and the silicon layers that constitute the TFT elements 511 may be formed using the liquid material arrangement method described above. Specifically, these components may be formed by arranging a liquid material that includes the corresponding functional material in a pattern on a substrate, and curing the arranged liquid material.

In the case of the color filters 505R, 505G, 505B, for example, a liquid material that includes pigments in the corresponding colors R, G, and B may be arranged in regions corresponding to pixels that are partitioned by the upper-layer banks 503, and the liquid material may be dried to form the color filters. The opposing electrode 507, the pixel electrode 510, and other metal films may be formed by arranging and baking a liquid dispersion of metal microparticles. The orientation films may be formed by arranging and drying a polyimide solution.

Such a method makes it possible to form each functional film in a state in which the discharge quantity of the liquid material is adjusted with high precision. A product can therefore be obtained that has good quality with regard to film thickness and uniformity of profile.

The present invention is not limited by the embodiments described above.

For example, the nozzle formation surface, a flow channel inside the heads, the liquid material feeding mechanism for feeding the liquid material to the heads, and other positions can be cited as other examples of the position in which the temperature of the head environment is detected.

An infrared camera or the like that is provided with a temperature analysis device, or the like may be cited as a modification example of the method for detecting the temperature in the head environment.

Other examples in which the abovementioned liquid material arrangement method is used include the formation of a fluorescent film in a plasma display device, and other examples.

The configurations described in the embodiments may also be appropriately combined, omitted, or combined with other configurations not shown in the drawings.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A liquid material arrangement method for arranging a liquid material on a discharge object with the liquid material being discharged from a nozzle of a head according to an electrical signal supplied to a drive unit, the liquid material arrangement method comprising:
measuring a discharge quantity of the liquid material discharged from the nozzle according to the electrical signal corresponding to a prescribed condition;
detecting a first temperature in a vicinity of the head while the discharge quantity is measured;
detecting a second temperature in the vicinity of the head in a condition in which the liquid material is discharged onto the discharge object; and
generating the electrical signal corresponding to a condition determined based on the discharge quantity, the first temperature and the second temperature, and supplying the generated electrical signal to the head to arrange the liquid material on the discharge object.

2. The liquid material arrangement method according to claim 1, wherein
the condition of the electrical signal includes a voltage component.

3. The liquid material arrangement method according to claim 1, wherein
the detecting of the first and second temperatures include detecting at least one of a temperature at a periphery of a surface of the head on which the nozzle is formed and a temperature at a periphery of an introduction part for introducing the liquid material to the head.

4. The liquid material arrangement method according to claim 1, wherein
the detecting of the second temperature and the generating of the electrical signal are performed one or more times for the discharge object.

5. The liquid material arrangement method according to claim 1, further comprising
discharging the liquid material from a plurality of heads,
the detecting of the first and second temperatures including detecting one of a temperature of one portion of the heads and a temperature of each of the heads.

6. A method for manufacturing a device that is provided with a film as a constituent element, the method comprising:
performing the liquid material arrangement method according to claim 1 to arrange the liquid material on a substrate; and
curing the liquid material arranged on the substrate to form the film.

7. A liquid material arrangement method for arranging a liquid material on a discharge object with the liquid material being discharged from a nozzle of a head according to an electrical signal supplied to a drive unit, the liquid material arrangement method comprising:
measuring a first preliminary discharge quantity of the liquid material discharged in a first area of the discharge object according to the electrical signal corresponding to a prescribed condition;
measuring a second preliminary discharge quantity of the liquid material discharged in a second area that is separate from the first area according to the electrical signal corresponding to the prescribed condition;
measuring a discharge quantity of the liquid material discharged in the second area in a condition in which the liquid material is discharged onto the discharge object according to the electrical signal corresponding to the prescribed condition; and
generating the electrical signal corresponding to a condition determined based on the first and second preliminary discharge quantities and the discharge quantity, and supplying the generated electrical signal to the head to arrange the liquid material on the discharge object.

8. The liquid material arrangement method according to claim 7, wherein
the condition of the electrical signal includes a voltage component.

9. A method for manufacturing a device that is provided with a film as a constituent element, the method comprising:
performing the liquid material arrangement method according to claim 7 to arrange the liquid material on a substrate; and
curing the liquid material arranged on the substrate to form the film.

10. A liquid material discharge device comprising:
a head including a nozzle configured and arranged to discharge a liquid material according to an electrical signal supplied to a drive unit;
a discharge quantity measurement section configured and arranged to measure a discharge quantity of the liquid material discharged on to a discharge object according to the electrical signal corresponding to a prescribed condition;
a first temperature detecting section configured and arranged to detect a first temperature in a vicinity of the head while the discharge quantity is measured by the discharge quantity measurement section;
an arrangement control section configured to discharge the liquid material from the nozzle to arrange the liquid material on the discharge object;
a second temperature detecting section configured to detect a second temperature in the vicinity of the head in a condition in which the liquid material is discharged onto the discharge object by the arrangement control section; and
an electrical signal control section configured to control a condition of the electrical signal that is supplied to the drive unit during arrangement of the liquid material by the arrangement control section based on the discharge quantity, the first temperature and the second temperature.

11. The liquid material discharge device according to claim 10, wherein
the condition of the electrical signal includes a voltage component.

12. The liquid material discharge device according to claim 10, wherein
the first and second temperature detecting sections are configured and arranged to detect at least one of a temperature at a periphery of a surface of the head on which the nozzle is formed and a temperature at a periphery of an introduction part for introducing the liquid material to the head.

13. The liquid material discharge device according to claim 10, wherein
the second temperature detecting section is configured and arranged to detect the second temperature for one or more times for the discharge object.

14. The liquid material discharge device according to claim 10, further comprising
an additional head including an additional nozzle configured and arranged to discharge the liquid material according to the electrical signal supplied to a drive unit,
the first and second temperature detecting sections being configured and arranged to detect one of a temperature of one portion of the head and the additional head and a temperature of each of the head and the additional head.
